(19) United States
(12) Patent Application Publication
(10) Pub. No.: US 2003/0126316 A1
(43) Pub. Date: Jul. 3, 2003

(54) System and method for print outcome notification

(76) Inventor: Abbie Parker, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/033,622

(22) Filed: Dec. 27, 2001

(51) Int. Cl. G06F 3/00

(52) U.S. Cl. 710/15

(57) ABSTRACT

The present disclosure relates to a system and method for print outcome notification. In one arrangement, the system and method pertain to determining which print settings are selected, determining whether one or more of the print settings is likely to adversely affect a printing result, and providing notification to a user that a selected print setting may result in an adverse printing result.

### FIELD OF THE INVENTION

The present disclosure relates to a system and method for print outcome notification. More particularly, the disclosure relates to a system and method with which the user can be warned as to the consequences of the use of certain print settings on the print outcome.

### BACKGROUND OF THE INVENTION

Many of today's printing devices (e.g., printers) present the user with various different print settings or options that the user can choose for print jobs. For instance, the user can choose the type of media that will be used, the resolution the generated document will have, reduced toner printing, etc. Typically, these settings are adjusted with a user interface of the printing device driver or user application from which the printable data originates or which is used to identify the printable data.

Although allowing greater flexibility to the user in creating print jobs, adjustment of print settings can adversely affect the printing results. For example, several of the settings can reduce print quality while others can increase the amount of time that will be required for printing. To cite another example, some settings may greatly increase the consumption of “consumables” such as toner and ink.

Often times, users are not aware of the adverse results that can arise when print settings are adjusted. Accordingly, it is somewhat common for users to adjust one or more print settings, initiate the printing process, and be dissatisfied or frustrated at the print outcome. For instance, if the user has adjusted a print setting that, unbeknownst to the user, will reduce print quality and then prints a large presentation document, the user is likely to be disappointed with the print result as well as with the prospect of having wasted both time and print media (e.g., paper).

In view of the problems identified above, it can be appreciated that it would be desirable to have a system and method that can notify the user of the possibility for an adverse printing result in view of selected print settings.

### SUMMARY OF THE INVENTION

The present disclosure relates to a system and method for print outcome notification. In one arrangement, the system and method pertain to determining which print settings are selected, determining whether one or more of the print settings is likely to adversely affect a printing result, and providing notification to a user that a selected print setting may result in an adverse printing result.

The disclosure also relates to a computer-readable medium that includes software configured to provide print outcome notification. In one arrangement, the computer-readable medium comprises logic configured to determine which print settings are selected, logic configured to determine whether one or more of the print settings is likely to adversely affect a printing result, and logic configured to provide notification to a user that a selected print setting may result in an adverse printing result.

Other systems, methods, features, and advantages of the invention will become apparent upon reading the following specification, when taken in conjunction with the accompanying drawings.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 is a schematic view of an example system in which the invention can be implemented.

FIG. 2 is a schematic view of a computing device shown in FIG. 1.

FIG. 3 is a flow diagram that provides an example of use of a computing device in which the user is notified as to potential adverse printing results.

FIG. 4 is a flow diagram that illustrates operation of a print outcome notification module shown in FIG. 2.

FIG. 5 illustrates an example of a notification that can be presented to a user.

### DETAILED DESCRIPTION

Disclosed herein is a system and method for print outcome notification. To facilitate description of the system and method, an example system in which the invention can be implemented will first be discussed with reference to the figures. Although this system is described in detail, it will be appreciated that this system is provided for purposes of illustration only and that various modifications are feasible without departing from the inventive concept. After the example system has been described, examples of operation of the system will be provided to explain the manners in which notifications regarding print outcome can be generated and presented to the user.

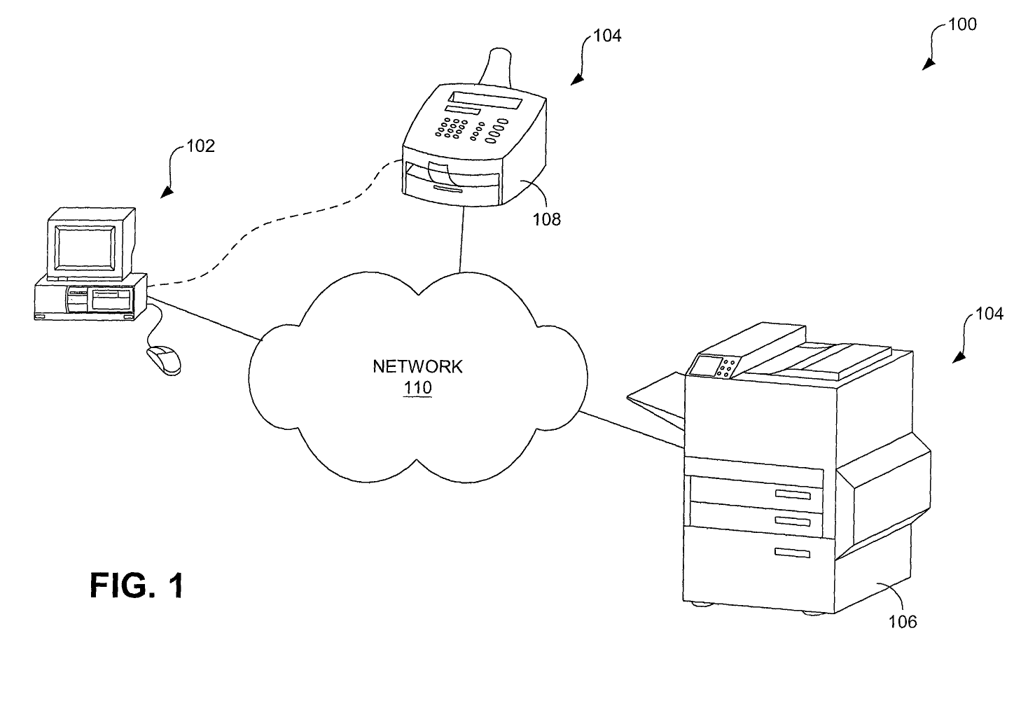

Referring now in more detail to the drawings, in which like numerals indicate corresponding parts throughout the several views, FIG. 1 illustrates an example system 100. The system 100 generally comprises a computing device 102 and one or more printing devices 104. As indicated in FIG. 1, the computing device 102 can comprise a desktop personal computer (PC). More generally, however, the computing device 102 comprises any device that is capable of accessing and using the printing devices 104 and, more particularly, which is capable of communicating with the printing devices by transmitting data to and/or receiving data from the printing devices. Therefore, by way of example, the computing device 102 can comprise a PC, Macintosh, notebook computer, server, handheld computing device (e.g., personal digital assistant (PDA), mobile telephones), etc.

The printing devices 104 can comprise, for example, a printer 106 or a multifunction peripheral (MFP) 108. However, it will be appreciated the printing device(s) can comprise any device that is capable of generating hardcopy documents including photocopiers, facsimile machines, etc. The present disclosure applies equally to all such devices.

As is further identified in FIG. 1, the computing device 102 and the printing devices 104 can, optionally, be connected to a network 110 that typically comprises one or more sub-networks that are communicatively coupled to each other. By way of example, these networks can include one or more local area networks (LANs) and/or wide area networks (WANs). Indeed, in some embodiments, the network 110 may comprise a set of networks that forms part of the Internet. As is depicted in FIG. 1, the computing device 102 can be directly connected to a printing device 104 (e.g., MFP 108). Such an arrangement is likely in a home environment in which the user does not have a home network or in an office environment where the printing device(s) 104 is/are used locally. In such a scenario, communications can be facilitated with a direct electrical and/or optical connection, or through wireless communication.

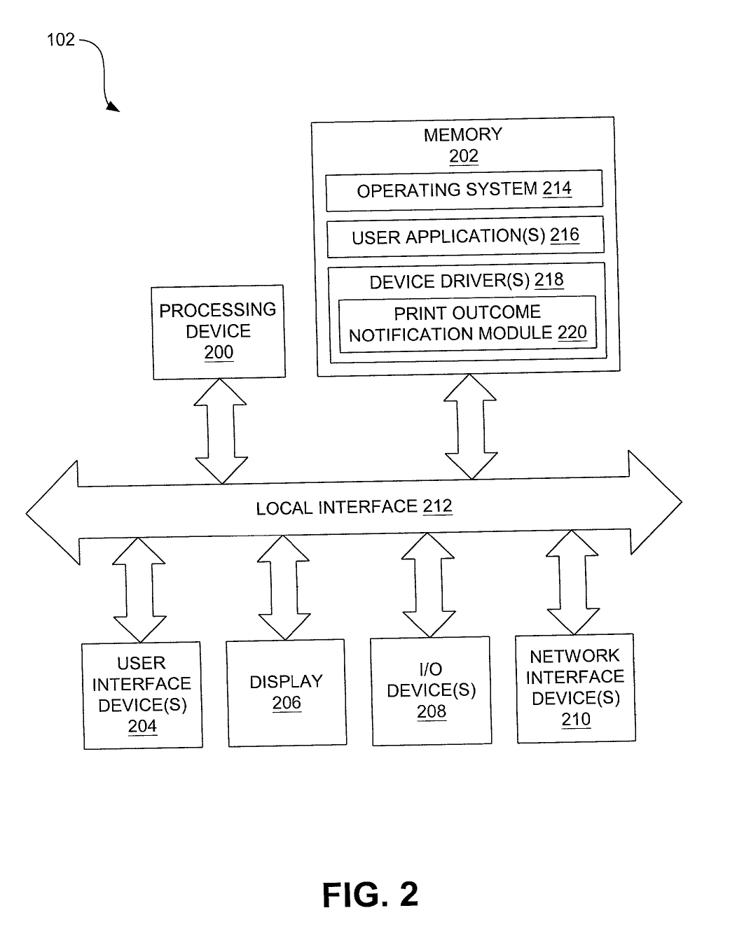

FIG. 2 is a schematic view illustrating an example architecture for the computing device 102 shown in FIG. 1. As indicated in FIG. 2, each computing device 102 can comprise a processing device 200, memory 202, one or more user interface devices 204, a display 206, one or more input/output (I/O) devices 208, and one or more network interface devices 210, each of which is connected to a local interface 212 that can comprise one or more internal and/or external buses. The processing device 200 can include any custom made or commercially available processor, a central processing unit (CPU) or an auxiliary processor among several processors associated with the computing device 102, a semiconductor based microprocessor (in the form of a microchip), or a macroprocessor. The memory 202 can include any one of a combination of volatile memory elements (e.g., random access memory (RAM, such as DRAM, SRAM, etc.)) and nonvolatile memory elements (e.g., ROM, hard drive, tape, CDROM, etc.).

The one or more user interface devices 204 comprise those components with which the user can interact with the computing device 102. By way of example, these components can comprise a keyboard, mouse, and/or trackball. Where the computing device 102 comprises a handheld device (e.g., PDA, mobile telephone), these components can comprise function keys or buttons, a touch-sensitive screen, etc. The display 206 can comprise a computer monitor or plasma screen, or a liquid crystal display (LCD) for a handheld device.

With further reference to FIG. 2, the one or more I/O devices 208 are adapted to facilitate connection of the computing device 102 to another device, such as a printing device 104, and may therefore include one or more serial, parallel, small computer system interface (SCSI), universal serial bus (USB), IEEE 1394 (e.g., Firewire™), and/or personal area network (PAN) components. The network interface devices 210 comprise the various components used to transmit and/or receive data over the network 110. By way of example, the network interface devices 210 include a device that can communicate both inputs and outputs, for instance, a modulator/demodulator (e.g., modem), wireless (e.g., radio frequency (RF)) transceiver, a telephonic interface, a bridge, a router, network card, etc.

The memory 202 normally comprises an operating system 214, one or more user applications 216, and one or more device drivers 218. The operating system 214 controls the execution of other software and/or firmware and provides scheduling, input-output control, file and data management, memory management, and communication control and related services. The user applications 216 comprise applications that execute on the computing device 102 and which can be used to access and use the printing devices 104. By way of example, the user applications 216 can include various source applications that are used to create, modify, and/or identify data to be transmitted to a printing device 104. For instance, the user applications 216 can include a word processing application, an image manager, etc.

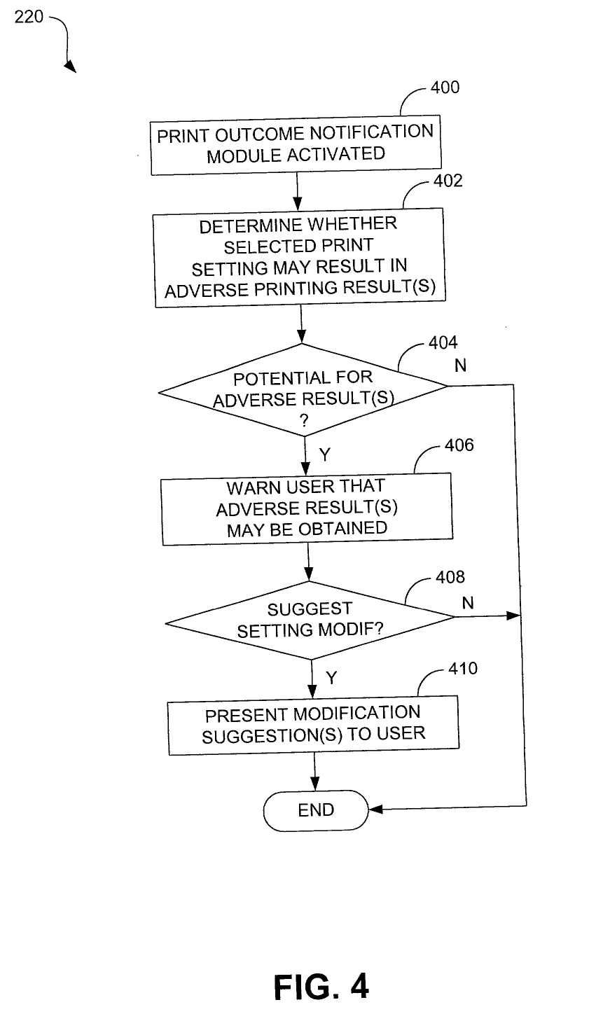

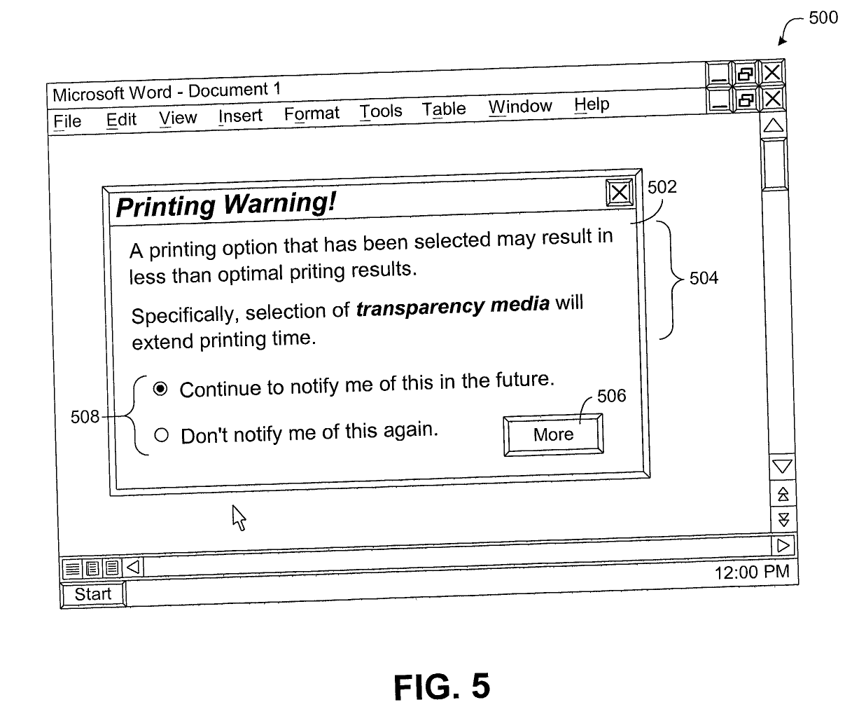

The one or more drivers 218 comprise software and/or firmware that is used to translate data output or identified by the user applications 216 into a format (i.e., language) which is suitable for the printing devices 104. Although shown as being provided in the memory 202 of the computing device 102, persons having ordinary skill in the art will recognize that the one or more drivers 218 can be located on another device, such as a printing device 104, if desired. The drivers 218 normally include one or more applications which comprise user interfaces (e.g., graphical user interfaces (GUIs)) with which the user can input selections or commands to the drivers. As indicated in FIG. 2, one or more of the device drivers 218 include a print outcome notification module 220. As is discussed below, the print outcome notification module 220 can be used to warn users as to potentially adverse effects a selected print setting may have on printing. The operation of the print outcome notification module 220 is described below with reference to FIGS. 4 and 5.

Various software and/or firmware programs have been described herein. It is to be understood that these programs can be stored on any computer-readable medium for use by or in connection with any computer-related system or method. In the context of this document, a computer-readable medium is an electronic, magnetic, optical, or other physical device or means that can contain or store a computer program for use by or in connection with a computer-related system or method. These programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium include an electrical connection having one or more wires, a portable computer diskette, a random access memory (RAM), a read-only memory (ROM), an erasable programmable read-only memory (EPROM, EEPROM, or Flash memory), an optical fiber, and a portable compact disc read-only memory (CDROM). Note that the computer-readable medium can even be paper or another suitable medium upon which a program is printed, as the program can be electronically captured, via for instance optical scanning of the paper or other medium, then compiled, interpreted or otherwise processed in a suitable manner if necessary, and then stored in a computer memory.

An example system 100 having been described above, operation of the system will now be discussed. In the discussion that follows, flow diagrams are provided. It is to be understood that any process steps or blocks in these flow diagrams represent modules, segments, or portions of code that include one or more executable instructions for implementing specific logical functions or steps in the process. It will be appreciated that, although particular example process steps are described, alternative implementations are feasible. Moreover, steps may be executed out of order from that shown or discussed, including substantially concurrently or in reverse order, depending on the functionality involved.

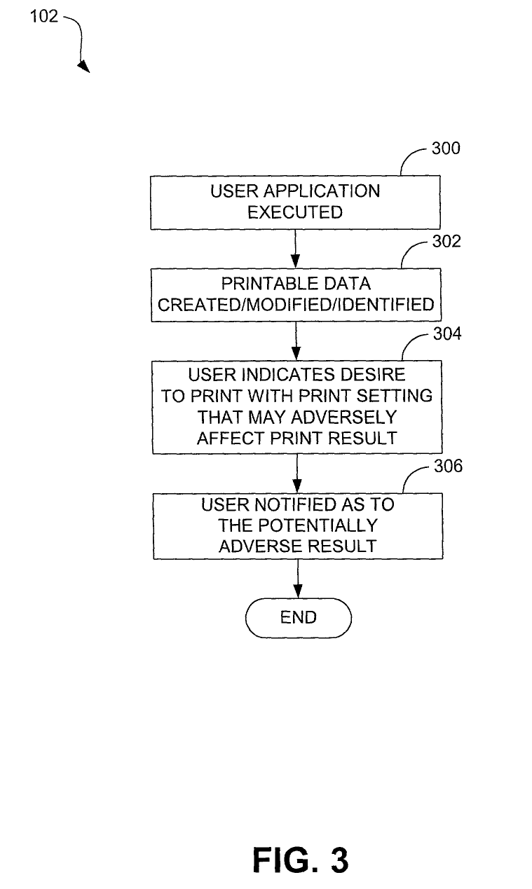

As discussed above, the invention can be used to warn users as to the consequences of selecting a print setting may have on the print outcome prior to transmission of a print job to the printing device 104. FIG. 3 provides an overview of this functionality with an example of use of the computing device 102. Beginning with block 300, a user application 216 is executed on the computing device 102. As noted above, this user application comprise any application that can be used to create, modify, or identify printable data. Next, printable data is created, modified, and/or identified using the user application 216, as indicated in block 302. For instance, the user can have typed text within a user interface of a word processing application or identified one or more images that the user would like to print with an image manager.

At this point, the user indicates that he or she would like to print some printable data with a print setting or option that may adversely affect the print result that will be obtained, as indicated in block 304. Examples of the types of print settings that may adversely affect the printing result(s) are described below. It suffices to say, however, that the print setting, either one explicitly selected by the user or currently set as a default, may result in a circumstance of which the user may not aware. Once the desire to print with such a print setting is received, the user is notified as to the potentially adverse result, as indicated in block 306.

FIG. 4 provides an example of operation of the print outcome notification module 220 illustrated in FIG. 2. Beginning with block 400, the notification module 220 is activated. This activation can occur in a variety of ways. For instance, the notification module 220 can be activated upon the selection of a new print setting. By way of example, the user can have selected the print setting by selecting a button or marking an appropriate checkbox presented to the user in a dialogue box that appears when a “print” command selected out of a “file” menu or when a “printer” button is selected (e.g., to change the default print settings). Alternatively, the notification module 220 can be activated upon the receipt of a print request registered with the user application 218. For instance, the user can have selected a “print” button from the user application GUI.

In any case, the notification module 220 can determine whether one or more print settings have been selected that may result in an adverse printing result, as indicated in block 402. As will be appreciated by persons having ordinary skill in the art, many different print settings may result in adverse printing results of one sort or another. For instance, several of the print setting selections (i.e., print factors) may adversely affect the print quality of the hard copy document that is generated by the printing device 104. Factors that can adversely affect print quality include, for example, use of recycled media, use of relatively thick media (to which it can be difficult to adhere toner), use of rough-textured media, use of an economy mode in which less toner is used in print jobs, etc. Although various print factors have been explicitly cited, persons having ordinary skill in the art will appreciate that various other factors that the user can control can adversely affect print quality.

Adverse results do not necessarily have to pertain to print quality. For example, other results that the user may deem adverse include prolonged print times (i.e., decreased performance), consumption of large amounts of consumables (e.g., ink or toner), increased potential for printing device jams, and the like. By alerting the user as to the possibility of such adverse results, the user can make an informed decision as to how to proceed with his or her print job and become educated as to reasonable expectations for future print jobs.

Referring now to decision element 404, it is determined whether one or more adverse results is or is not likely to occur. If an adverse result is not likely to occur, i.e., the new print setting selected by the user or the print setting currently used as a default would not likely result in an unexpected adverse result, flow for the session is terminated and, if a print request was received, the print process continues to completion. If, on the other hand, an adverse result is likely (e.g., due to one of the factors cited above), flow continues on to block 406 at which the user is warned that the adverse result or results may occur. In other words, the notification module 220 notifies the user as to the likelihood that one or more adverse results will be obtained.

The notification provided to the user can, for example, comprise the display of a pop-up dialogue box that identifies that an adverse result may occur and, more specifically, identifies the particular adverse result that may be obtained. FIG. 5 illustrates an example of such a notification. More specifically, FIG. 5 illustrates a user application GUI 500 in which a dialogue box 502 has been presented to the user (e.g., in response to the user selecting “print” from the “file” menu). In the example of FIG. 5, the user application comprises a word processing application and, more particularly, Microsoft Word™. Although this particular user application has been identified, it is to be appreciated that this application is used for purposes of illustration only.

As indicated in FIG. 5, the dialogue box 502 can include text 504 that identifies that an adverse result may occur, as well as the particular print setting that could bring about the adverse result and the particular nature of the adverse results. In addition, the dialogue box 502 can include a button 506 (or other selectable feature) with which the user can obtain more information. For instance, where the adverse result is a decrease in print quality, the user could obtain more specific information about the extent of the print quality reduction (e.g., in terms of loss of resolution, increase in artifacts, etc.). Therefore, if interested, the user can “drill down” to obtain more information that may help the user in deciding how to proceed both for the present print job and for future print jobs. The dialogue box 502 additionally can include options 508 to either continue to be warned or to no longer be warned when the same condition arises again.

Returning to FIG. 4, it can further be determined whether the notification module 220 is to suggest an alternative print setting that will not likely cause an adverse printing result, as indicated in decision element 408. By way of example, this functionality can be enabled/disabled by the user as a option. If no suggestions are to be provided, flow is terminated. If, on the other hand, one or more suggestions are to be provided, flow continues to block 410 at which the print setting suggestion(s) is/are presented to the user. By way of example, the suggestion(s) can be presented to the user along with the dialogue box that first alerted the user to the potential problem, or in another dialogue box or other mechanism that the user can access. The suggestions can comprise, for instance, suggestions to use different print media, suggestions to enable an alternative toner usage option, etc. In some arrangements, the notification module 220 can further be configured to, with the user's permission, automatically change the print setting such that adverse results will not likely occur.

Once the suggestion(s) is/are provided, flow for the notification module 220 is terminated. At this point, the user can either override the warning and, where provided, suggestion(s) or heed the warning and return to the user application 216.

Operating in the manner described above, the print outcome notification module 220 can be used to avoid potentially frustrating situations by providing education as to how print settings can affect the generated product. Accordingly, the user can be prompted to prevent adverse print results before they occur.

While particular embodiments of the invention have been disclosed in detail in the foregoing description and drawings for purposes of example, it will be understood by those skilled in the art that variations and modifications thereof can be made without departing from the scope of the invention as set forth in the following claims. For instance, although the invention has been described in terms of “selected” print settings, persons having ordinary skill in the art will appreciate that, where the printing device is capable of providing the notification module with feedback, notifications may be generated if potentially problematic types of media are detected by the printing device.

What is claimed is:

1. A method for providing print outcome notification, comprising the steps of:
determining which print settings are selected;
determining whether one or more of the print settings is likely to adversely affect a printing result; and
providing notification to a user that a selected print setting may result in an adverse printing result.

2. The method of claim 1, wherein the step of determining which print settings are selected comprises determining a print setting that has been selected by the user.

3. The method of claim 1, wherein the step of determining which print settings are selected comprises determining a current default print setting.

4. The method of claim 1, wherein the step of determining whether one or more of the print settings is likely to adversely affect a printing result comprises determining whether one or more of the print settings is likely to adversely affect at least one of print quality, print speed, and consumption of a printing device consumable.

5. The method of claim 1, wherein the step of providing notification comprises facilitating presentation of a warning dialogue box to the user.

6. The method of claim 1, wherein the step of providing notification comprises providing an indication of the degree of severity of the adverse result.

7. The method of claim 1, further comprising the step of suggesting an alternative print setting that will not likely result in an adverse printing result.

8. The method of claim 7, further comprising the step of automatically adjusting a print setting for the user so as to avoid an adverse printing result.

9. A system for providing print outcome notification, comprising:
means for determining which print settings are selected;
means for determining whether one or more of the print settings is likely to adversely affect a printing result; and
means for providing notification to a user that a selected print setting may result in an adverse printing result.

10. The system of claim 9, wherein the means for determining whether one or more of the print settings is likely to adversely affect a printing result comprise means for determining whether one or more of the print settings is likely to adversely affect at least one of print quality, print speed, and consumption of a printing device consumable.

11. The system of claim 9, wherein the means for providing notification comprise means for facilitating presentation of a warning dialogue box to the user.

12. The system of claim 9, further comprising means for suggesting an alternative print setting that will not likely result in an adverse printing result.

13. A system that includes software configured to provide print outcome notification, comprising:
logic configured to determine which print settings are selected;
logic configured to determine whether one or more of the print settings is likely to adversely affect a printing result; and
logic configured to provide notification to a user that a selected print setting may result in an adverse printing result.

14. The system of claim 13, wherein the logic configured to determine whether one or more of the print settings is likely to adversely affect a printing result comprises logic configured to determine whether one or more of the print settings is likely to adversely affect at least one of print quality, print speed, and consumption of a printing device consumable.

15. The system of claim 13, wherein the logic configured to provide notification comprises logic configured to facilitate presentation of a warning dialogue box to the user.

16. The system of claim 13, further comprising logic configured to suggest an alternative print setting that will not likely result in an adverse printing result.

17. The system of claim 13, further comprising logic configured to cancel printing.
